(19) United States
(12) Patent Application Publication
(10) Pub. No.: US 2003/0155512 A1
(43) Pub. Date: Aug. 21, 2003

(54) Apparatus and method for investigating a sample

(76) Inventors: Donald Dominic Arnone, Cambridgeshire (GB); Craig Michael Ciesla, Cambridgeshire (GB); Bryan Edward Cole, Cambridgeshire (GB)

Correspondence Address: OSTROLENK FABER GERB & SOFFEN, 1180 AVENUE OF THE AMERICAS, NEW YORK, NY, 100368403

(21) Appl. No.: 10/220,476

(22) PCT Filed: Feb. 28, 2001
(86) PCT No.: PCT/GB01/00859

(30) Foreign Application Priority Data
Feb. 28, 2000 (GB) 0004667.2

(51) Int. Cl. G01N 21/63

(52) U.S. Cl. 250/341.1

(57) ABSTRACT

An apparatus and method for investigating a sample, the apparatus comprising: means (61) for irradiating the sample (21) with a first beam of electromagnetic radiation configured to excite an optically non-linear process within the sample; means (61) for irradiating the sample with a second beam of electromagnetic radiation; and a detector (41) for detecting a change the second beam after it has been reflected from or transmitted through the sample. If the optically non-linear process is a second order process, the detector could be used to detect a change in the polarisation of the second beam. Apparatus and method find application of samples with terahertz (THZ) radiation locally generated and detected within the sample.

The present invention relates to a method and apparatus for investigating a sample, for example, by obtaining images or spectra of the sample. More specifically, the present invention is concerned with investigating a sample by using the optically non-linear inherent properties of the sample.

Recently, there has been interest in producing images and obtaining spectra from samples using radiation in the frequency range from 25 GHz to 100 THz. This frequency range encompasses the far-infrared part of the spectrum as well at the start of the microwave region. This frequency range is often referred to as the Terahertz (THz) frequency range. Previous THz investigation techniques have used THz radiation to irradiate a sample and then detect the emitted radiation.

As there is no good efficient natural source of THz radiation, THz radiation is typically produced by using a frequency conversion member to change the frequency of an input pump beam or beams. A commonly used method is to produce THz radiation from an optically non-linear member which exhibits χ⁽²⁾ non-linearity. Often, the member is configured to emit radiation with a frequency which is equal to the difference in frequency of two signals incident on the member.

A particularly useful way to detect THz radiation is to use the AC Pockels effect. When linearly polarised radiation of a suitable wavelength, (for example, a beam in the visible or near infrared parts of the spectrum) is passed through a suitable detection crystal with THz radiation, its polarisation vector is rotated. The extent of the rotation of the polarisation is dependent on the THz signal. In the absence of a THz signal, no change in the rotation of the polarisation of the linearly polarised beam or ‘probe’ beam is observed.

THz radiation suffers from the problem that it inherently has a poor penetration depth especially in structures with relatively high water contents. This makes THz imaging of biological structures difficult.

The present invention seeks to address the above problem by using the inherent non-linear optical properties sample under investigation to convert the pump beam into THz radiation and to encode THz information on a probe beam. In other words, the THz radiation can be thought of as being locally generated and detected within the sample. Use of the inherent non-linear properties of a sample to obtain information about a sample have been previously suggested by Zumbusch et al, Phys Rev Lett. 82, p4142 (1999). Here, the author's looked at the response of a system to continuous radiation.

In a first aspect, the present invention provides an apparatus for investigating a sample, the apparatus comprising means for irradiating the sample with a first beam of electromagnetic radiation configured to excite a second order non-linear process within the sample, means for irradiating the sample with a second beam of electromagnetic radiation; and a detector for detecting a change in the polarisation of the second beam after the second beam has been reflected from or transmitted through the sample.

In a second aspect, the present invention provides an apparatus for investigating a sample, the apparatus comprising:

means for irradiating the sample with a first beam of electromagnetic radiation configured to excite an optically non-linear process within the sample such that radiation with a frequency of less than that of the first beam is generated within the sample;

means for irradiating the sample with a second beam of electromagnetic radiation;

and a detector for detecting the second beam after it has been reflected from or transmitted through the sample.

Preferably the detector will be configured to detect the polarisation of the second beam. However, other characteristics of the second beam which are also affected by the local THz field could also be detected by the detector.

Not all materials possess χ⁽²⁾ properties. However, all materials possess χ⁽³⁾ properties to a certain level. It is possible to induce second order non-linearities (χ⁽²⁾) in a sample from third order non-linearities (χ⁽³⁾).

Therefore, preferably, the present invention further comprises inducing means for inducing an effective second order non-linearity from a third order non-linearity.

Means for inducing a second order non-linearity may comprise means for applying a static or slowly varying electric field as χ⁽²⁾=χ⁽³⁾x applied electric field.

Any sample which is to be imaged will be made up of molecules. The electrons in each molecule will be confined within a potential. The exact shape of the potential will depend on the specific molecule and its surroundings. Such electron confinement potentials are generally non-parabolic and some can be approximated to flat bottomed U-shapes or potentials where the walls at the side of the potential vary with an inverse square relationship to their distance from the centre of the potential.

Without wishing to be bound by any theory, a simplified explanation of a mechanism which it is believed the present invention uses to investigate the sample will be explained using a flat-bottomed “U”-shaped potential well. The equilibrium position of the electron is at the centre of the “U” shaped well. The inducing means serve to move the electron from this equilibrium position towards one of the walls of the “U”. This will be called the ‘biased’ rest position.

When the sample is irradiated with the first beam, which will hereinafter be referred to as the “pump” beam, the electron vibrates back and forth within the “U”. This has the net effect of moving the electron back towards the centre of the “U” as it is not energetically favourable for the electron to travel up the sides of the “U”. The electron will relax back to the first rest position once the pump beam stops exciting the electron. This relaxation causes the electron to emit a THz photon. The emitted THz photon can be detected by the second beam, which will hereinafter be referred to as the probe beam. The optically non-linear sample allows the polarisation of the probe beam to be rotated by the emitted THz.

In the apparatus of the first aspect of the present invention, the detector is used to measure this change in polarisation of the probe beam.

Hence, THz radiation can be used to obtain information about the internal structure of samples, as the problem of the shallow THz penetration depth is removed.

Typically, the probe beam and the pump beam will be polarised before they enter the sample. They may be linearly polarised or even circularly polarised. The degree of rotation of the probe beam is dependent on the strength of the THz signal.

Preferably, the detector comprises means for separating the orthogonal components of the probe beam. The detector preferably further comprises means for comparing the magnitudes of the two components.

The apparatus of the first and second aspects of the present invention can be used to image or obtain spectra from samples such as biological tissue for example, human tissue, it can also be used to image fluids such as water, glucose, etc.

Preferably, the pump beam and the probe beam will be polarised at an angle to each other, more preferably between 30° and 60° to one another.

The probe and pump beams may be at the same frequency or they may be of different frequencies. If the pump and probe beams have different frequencies, the transmitted or reflected pump and probe beams can be easily separated. Typically, they will be a visible or infrared frequency, for example in the range from 100 THz to 1000 THz.

The probe and pump beams are preferably pulsed beams which comprise a plurality of different frequencies. Preferably, the pulses are synchronised such that the pump beam effects a change in the position of the electron and the probe beam detects the relaxation of the electron in the absence of the pump beam. However, the relaxation of the electron could also be investigated by switching on and off a continuous wave pump beam.

Preferably, the apparatus comprises means for varying the delay between the pulses of the pump beam and the pulses of the probe beam reaching the sample.

The present invention may be used just to take spectra of a specific point on the sample.

Although it is possible to image parts of the sample where the probe and pulse beams are close to each but do not overlap, it is preferable if the probe and pulse beams do overlap. This may be achieved by crossing the probe and pump beams or by orienting the probe and pulse beams such that they are co-linear. By crossing the probe and pump beams it is possible to obtain an image of any point in the sample, as the probe beam will be predominantly affected by emission of Terahertz at the point of overlap of the pump beam and probe beam.

The overlap point of the probe beam and the pulse beam can preferably be scanned in any direction within the sample such that a slice of the sample or a selected volume of the sample can be imaged. An image of an area or a volume of the sample can be obtained by moving the probe and pump beams relative to the sample or by moving the sample relative to the two beams. Preferably, the apparatus is provided with means to vary the angle between the two beams to allow such images to be produced.

In a third aspect, the present invention provides a method of investigating a sample, the method comprising the steps of:

irradiating the sample with a first beam of radiation, the first beam being configured to excite a second order optically non-linear process within the sample;

irradiating the sample with a second beam of radiation; and

detecting a change in the polarisation of the second beam which has been reflected from or transmitted through the sample.

Preferably, the method also comprises the step of inducing a second order non-linearity from a third order optical non-linearity inherent in the sample.

In a fourth aspect, the present invention provides a method for investigating a sample, the method comprising the steps of:

irradiating the sample with first beam of electromagnetic radiation configured to excite an optically non-linear process within the sample such that radiation with a frequency of less than that of the first beam is generated within the sample;

irradiating the sample with a second beam of electromagnetic radiation;

and detecting the second beam after it has been reflected from or transmitted through the sample.

The present invention will now be described with reference to the following non-limiting preferred embodiments in which:

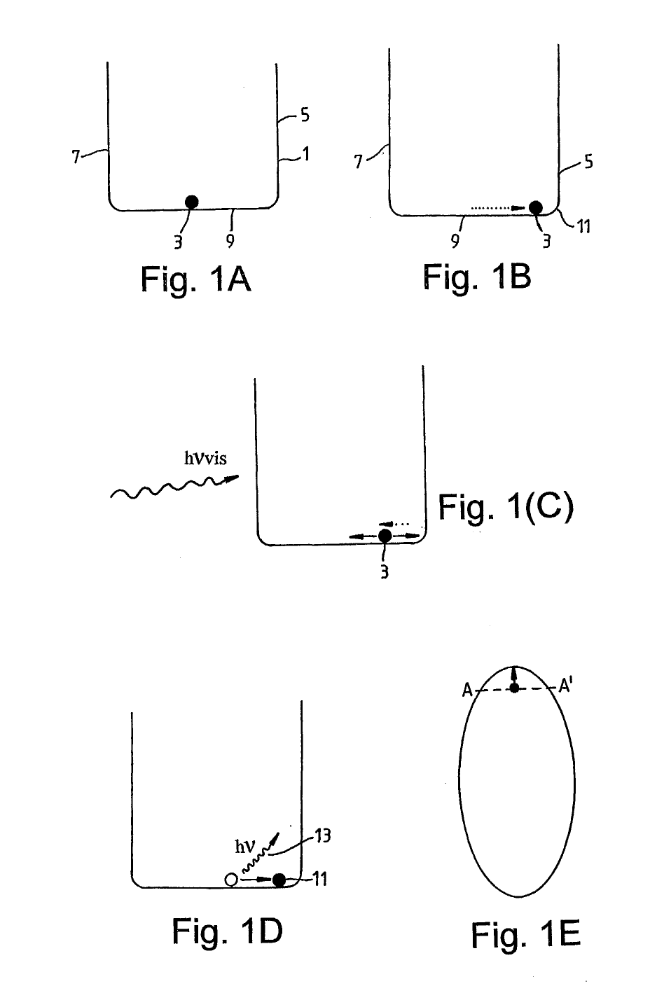

FIG. 1 shows a schematic of an electron confinement potential in a molecule;

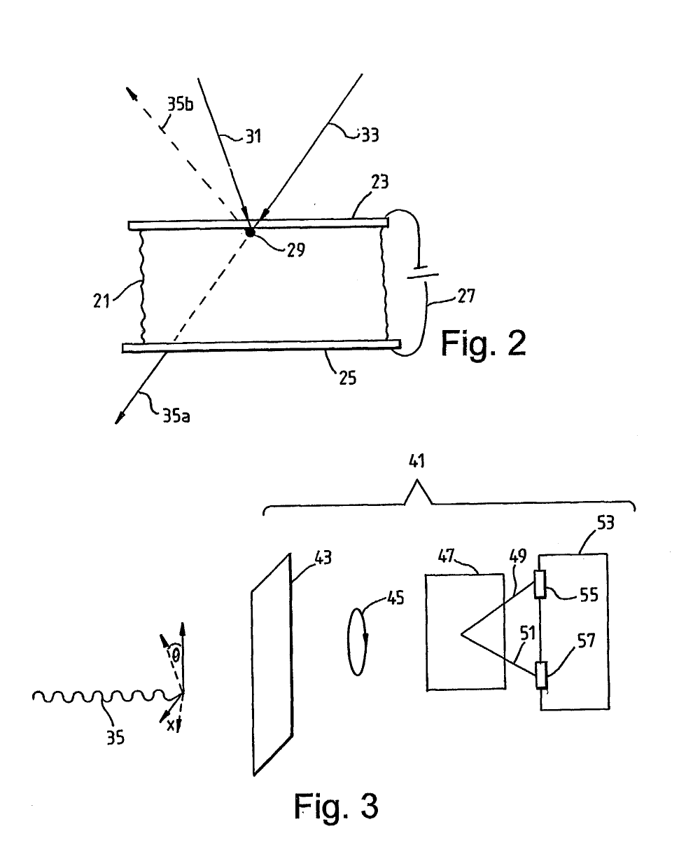

FIG. 2 shows an apparatus in accordance with a first embodiment of the present invention;

FIG. 3 shows a detector which may be used with an embodiment of the present invention;

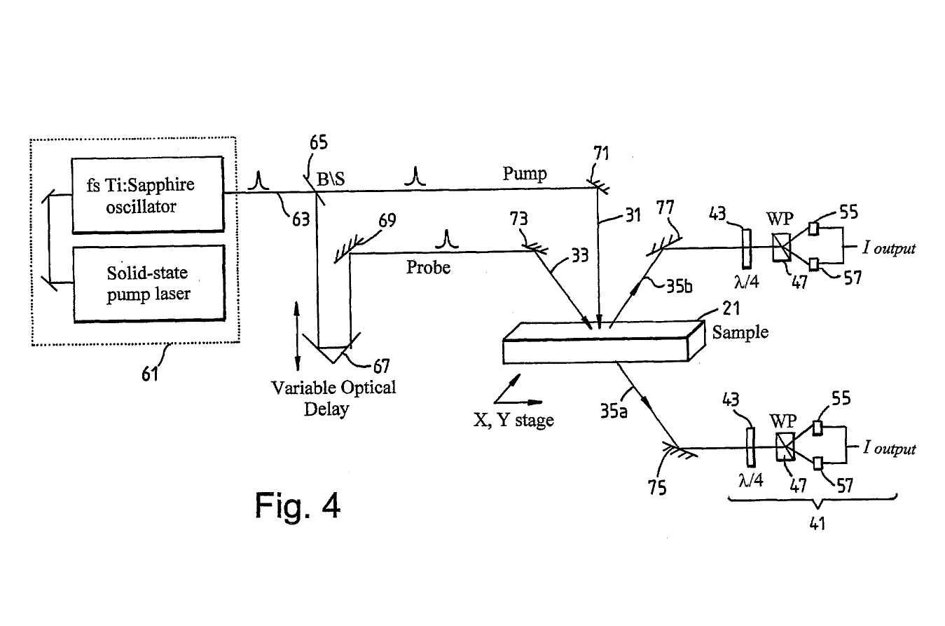

FIG. 4 shows an imaging system in accordance with an embodiment of the present invention; and

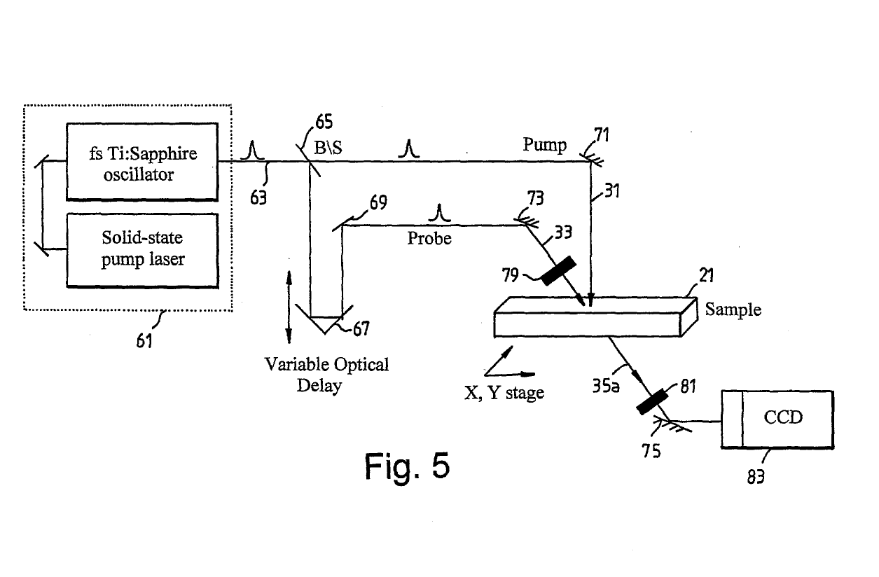

FIG. 5 shows the imaging system of FIG. 4 with a CCD camera.

Electrons in molecules are confined within confinement potentials which have many different shapes. FIG. 1A shows a so-called hard-wall potential. The hard-wall potential is chosen as an example for the purposes of this description and is not in any way intended to be limiting.

The potential can be visualised a flat-bottomed shape “U” with right 5 and left 7 vertical walls separated by flat bottom 9. In its equilibrium state, (i.e. without any external fields applied), the electron 3 resides in the centre of the flat bottom 9 of the potential. For simplicity, only a single electron will be considered at this stage.

The electron 3 can be moved from its equilibrium position by the application of a field such as a low frequency RF field, or a DC bias etc. This has the effect of moving or biasing the electron 3 to “biased” rest position 11 which is towards the right hand wall 5 as shown in FIG. 1B. The terms “left” and “right” are used with respect to the schematic diagrams. In practice, the direction of travel of the electron 3 will be dependent on the applied field.

FIG. 1C shows the sample under illumination with a linearly polarised pump beam. Irradiation of the sample with the pump beam causes the electron to oscillate about its biased rest position 11. However, the electron is restricted from moving too far over the right because of the right hand wall 5. Therefore, the actual oscillation centre is moved towards the centre of the potential.

When the pump beam is removed, as shown in FIG. 1D, the electron will relax back from this second position to the “biased” rest position 11. This relaxation of the electron essentially involves the emission of a THz photon 13. The emission can be detected by a linearly polarised probe beam. The emission of this THz photon 13 in the sample rotates the polarisation of the probe beam of radiation passing through the sample. The probe beam with the rotated polarisation exits the sample. Hence, information about how the electron relaxes back into the bias rest position can be easily detected.

The above description is just related to a single electron, in a real sample, millions of electrons will behave as described with reference to FIGS. 1A to 1D. Each of these electrons contributes to a microscopic THz wave.

The mechanism by which the THz signal propagates between the pump beam and the probe beam is dependent on characteristics of the sample such as its absorption coefficient and its refractive index.

How the properties of the sample are linked to the emitted THz radiation will now be described. The following theory is for so-called χ² detection. Not all materials possess such χ² properties. However, all materials have a certain level of χ³. Effective χ² properties may be created from χ³ properties by the application of an external electric field (E_{DC}) i.e. χ²=χ³.E_{DC}.

The following analysis considers only one spatial dimension, x (i.e. for the case of collinearly propagating collimated beams) for simplicity. The method is not significantly changed in the full 3D case, where the pump and probe may be deliberately non-collinear in order to facilitate the separation of the two beams at the detectors.

All field quantities are written in complex form, where i is the imaginary unit such that \sqrt{i}=−1 and the true fields are obtained by taking the Real part of the complex quantity.

The pump beam, which is has short-wavelength typically from 0.1 to 10 μm, induces a local, lower-frequency electric polarisation of the medium with magnitude proportional to the intensity of the field of the pump beam (i.e. proportional to the field amplitude squared or Eₚᵤₘₚ.Eₚᵤₘₚ*).

For the case of a χ² non-linearity, the component of the local polarisation along the i-th Cartesian co-ordinate axis (i=x, y, z) Pᵢ(x,t) is related to the local electric fields (due to an applied laser pulse, say) along the j-th and k-th axes, Eⱼ(x,t) and Eₖ(x,t) respectively, according to:

$${P}_{i} ( x , t ) = {\sum }_{{j = x , y , z}_{k = x , y , z}} {χ}_{ijk}^{( 2 )} \cdot {E}_{j} ( x , t ) \cdot {E}_{k} ( x , t ) \qquad Eq . 1$$

The coefficients χ⁽²⁾ᵢⱼₖ may take on different values according to the axis indices and for a linearly polarised pump beam, so only the components with j=k. need to be considered. Thus the induced polarisation may lie along a different axis to the pump beam polarisation axis. For clarity an induced polarisation along a single direction will be considered, hence the axis subscripts i,j,k can be dropped. The pump pulse has an electric field with the following form:

E(x,t)=A(x/ν−t)·sin(Kx−Ωt+φ),

where F=Ω/2π is the frequency of the pump pulse (typically in the range 100 THz to 1000 THz), λ=2π/K is the wavelength of the pump pulse in the sample medium and φ is an arbitrary phase factor. The function A(x/ν−t) describes the field amplitude envelop of the pump pulse; this function propagates with the group velocity,

$$v ( = \frac{ⅆ Ω}{ⅆ K} )$$

appropriate to the pump pulse frequency.

The low-frequency (i.e. THz) component of the induced polarisation can be derived by integrating the full polarisation over one period of the pump pulse radiation.

$$\begin{matrix}{P}_{THz} ( x , t ) = {\int }_{t}^{t + \frac{1}{f}} {{χ}^{( 2 )} ( E ( x , t ) )}^{2} ⅆ t \\ \approx {χ}^{( 2 )} {A ( \frac{x}{v} - t )}^{2} {\int }_{t}^{t + \frac{1}{f}} {( sin ( kx - ω t + φ ) )}^{2} ⅆ t \\ = \frac{1}{2} {χ}^{( 2 )} {A ( \frac{x}{v} - t )}^{2}\end{matrix}$$

it has been assumed that the envelop function, A(x/ν−t) varies slowly over one cycle of the pump pulse(i.e. from t to t+1/F).

Thus:

$$\begin{matrix}{P}_{THz} ( x , t ) = {χ}^{( 2 )} \cdot \frac{1}{2} {( A ( \frac{x}{v} - t ) )}^{2} \\ ∝ {χ}^{( 2 )} \cdot I ( \frac{x}{v} - t )\end{matrix}$$

where I(x/ν−t) is the local pump beam power density.

For example, a gaussian pulse is given by:

I(x/ν−t)=I₀e^{-((x/ν-t)/τ)}^{²},

where τ is the characteristic length of the pulse and I₀ it's peak height.

The THz electric field, E_{THz}, is related to the local induced polarisation, P_{THz}, (induced by the pump beam as described above, for example) of a medium according to the following differential equation (obtained directly from Maxwell's equations):

$$\frac{{ⅆ}^{2} {E}_{THz}}{ⅆ {x}^{2}} - {( \frac{k}{ω} )}^{2} \frac{{ⅆ}^{2} {E}_{THz}}{ⅆ {t}^{2}} = \frac{1}{{c}^{2} {ϵ}_{0}} \frac{{ⅆ}^{2} {P}_{THz}}{ⅆ {t}^{2}} , \qquad Eq . 2$$

where ƒ=2π/ω is the THz frequency, ε₀ is the vacuum electric permitivity and c is the velocity of light in a vacuum. k is related to co through:

$$k = \frac{n ω}{c} + i \frac{α}{2} ,$$

where, n is the refractive index of the sample medium and α is the absorption coefficient of the sample medium. Both n and α are functions of ω.

The left hand side of Equation 2 describes the propagation of the THz electric field while the right-hand side describes the ‘driving’ term, which generates the electric field.

For a driving polarisation of the form

$${P}_{THz} ( x , t ) = {\int }_{ω} {P}_{ω} {ⅇ}^{ⅈ ( q \cdot x - ω \cdot t )} \cdot ⅆ ω ,$$

where ƒ=ω/2π is the driving frequency and q is the complex wavevector of the polarisation and P_{ω} is the polarisation amplitude (which may be complex) at each frequency component ω. The ω-subscript indicates the quantity is a function of ω.

The resulting THz electric field is found by solution of Equation 2 to be

$${E}_{THz} ( x , t ) = {\int }_{ω} \frac{- {ω}^{2} {P}_{ω}}{{c}^{2} {ϵ}_{0} ( {k}^{2} - {q}^{2} )} {ⅇ}^{ⅈ ( q \cdot x - ω \cdot t )} \cdot ⅆ ω , \qquad Eq . 3$$

The presence of a low-frequency (THz) electric field, such as that induced by the inducing means, in a medium with a second-order (χ⁽²⁾) non-linear polarisation (as described by Equation 1) will induce a degree of birefringence in the medium proportional to the THz field strength.

As in the case of the generation of the THz polarisation, where a material has no intrinsic second order non-linearity (χ⁽²⁾), an effective χ⁽²⁾ may be induced from a third-order nonlinearity (always present), χ⁽³⁾ by the application of an external electric field

χ⁽²⁾ᵢⱼₖ=χ⁽³⁾ᵢⱼₖₗ·Eₗ (i,j,k,l indices denote direction axes)

The probe pulse is used to probe the local electric field at a known time-delay after the pump pulse, using the electro-optic effect:

A change of polarisation of the probe pulse occurs in proportion to the birefiingence of the sample medium which is, in turn, proportional to the low frequency (THz) electric field encountered by the pulse in the medium.

In this way, we measure the integral of E_{ω}(x,t) with respect to x over the sample interaction length to get

$$\begin{matrix}{E}_{THz} ( t - {t}^{′} ) = {\int }_{{interaction}_{length }} {E}_{THz} ( x , t ) \cdot {ⅇ}^{- ⅈ ( q \cdot x - ω {t}^{′} )} ⅆ x \\ = {\int }_{ω} \frac{- {ω}^{2} {lP}_{ω}}{{c}^{2} {ϵ}_{0} ( {k}^{2} - {q}^{2} )} {ⅇ}^{ⅈ ω ( t - {t}^{′} )} \cdot ⅆ ω ,\end{matrix} \qquad Eq . 3$$

where l is the sample interaction length and t-t′ is the time delay between pump and probe pulses and assuming that the probe beam has the same q (i.e. same refractive index and absorption coefficient) as that for the pump (as is the case if the same wavelength is used for the pump and probe). This assumption simplifies the analysis. The method may still be applied for pump and probe pulses of different wavelengths.

To obtain the characteristic sample parameter k in the frequency domain (i.e. k=k(ω)), we Fourier transform Equation 3 to get:

$$\frac{1}{2 π} \int E ( t - {t}^{′} ) {ⅇ}^{ⅈ ω ( t - {t}^{′} )} ⅆ ( t - {t}^{′} ) = \frac{- {ω}^{2} {lP}_{ω}}{{c}^{2} {ϵ}_{0} ( {k}^{2} - {q}^{2} )} \qquad Eq . 4$$

P_{ω} is obtained by Fourier transformation of the induced polarisation envelop:

$${P}_{ω} = \frac{1}{2 π} \int {P}_{THz} ( t - {t}^{′} ) {ⅇ}^{ⅈω ( t - {t}^{′} )} d ( t - {t}^{′} ) , \qquad \text{Eq. 5}$$

Since real measurements are performed on values sampled at discrete points in time, the above (and following) integral transforms are replaced with the appropriate discrete transforms.

Finally, the value of the material parameter k at any frequency, ω, is obtained by rearranging Equations 4 and 5 to get.

$${k}^{2} = \frac{- {ω}^{2} l \int P ( Δ t ) {ⅇ}^{ⅈω ( Δ t )} d ( Δ t )}{{c}^{2} {ϵ}_{0} \int E ( Δ t ) {ⅇ}^{ⅈω ( Δ t )} d ( Δ t )} - {q}^{2} \qquad \text{Eq. 6}$$

where E(Δt) is the THz electric field obtained by measurement from the electro-optic detection (i.e. this is the signal we measure), as a function of pump-probe pulse delay Δt=(t-t′). Both E and P are Real valued. The driving polarisation P(Δt) is obtained from the temporal envelope of the intensity of the pump pulse, I(Δt) according to

P(Δt)∝χ⁽²⁾·I(Δt).

q is determined as the wavevector of the high-frequency (near-infrared) envelope i.e.

$$q = \frac{ω}{{v}_{NIR}} + i \frac{{α}_{NIR}}{2} ,$$

where ν_{NIR} is the group velocity of the NIR wavepacket and α_{NIR} is the absorption coefficients at the pump or probe wavelength.

The refractive index and absorption coefficient of the medium at each THz frequency can be obtained from k according to:

$$k = \frac{n ω}{c} + i \frac{α}{2} .$$

It should be noted that FIGS. 1A to 1D show only a 1D confinement potential. FIG. 1E shows a two dimensional potential. This is the potential of FIG. 1 viewed from above. The line A-A′ is the line through which 1D potentials 1A to 1D are taken.

FIG. 2 shows a schematic arrangement of a sample 21 under investigation. The sample is located between an upper electrode 23 and a lower electrode 25. A bias 27 is applied between electrodes 23 and 25 in order to move the electrons from their equilibrium position to the biased rest position as shown in FIG. 1B. The sample is irradiated at point 29 by a pump beam 31 which is configured to excite the electron in the manner shown in FIG. 1C. A linearly polarised probe beam 33 is also focused on point 29. The relaxation of the electrons (as described with reference to FIG. 1D) rotates the polarisation of probe beam 33 in a non-linear medium due to the AC Pockels effect. The probe beam with rotated polarisation 35 is then emitted from the lower surface of the sample.

In order to allow illumination of the sample, electrodes 23, 25 are preferably NiCr with a thickness of 80 nm or less.

Either the transmitted 35a or reflected 35b probe beam can be measured.

The probe beam 35 which has been transmitted through or reflected from the sample 21 is then fed into the detector 41 as shown in FIG. 3. The probe beam 35 is first passed through quarter waveplate 43 which serves to circularly polarise the probe beam 45. The circularly polarised probe beam 45 is then passed into Wollaston Prism 47 which separates the two orthogonal polarised components 49 and 51 from the circularly polarised probe beam 45. These two components are then fed onto balanced photo-diode assembly 53. Balance photo-diode assembly 53 comprises two photo diodes 55 and 57 which each receive one of the orthogonally polarised components. The balance assembly 53 is configured such that it outputs a signal corresponding to the difference between the outputs of diodes 55 and 57. The output from diodes 55 and 57 will only be the same if there has been no rotation of the polarisation of the probe beam 35 i.e. if no THz signal was measured from the sample.

FIG. 4 shows a schematic of a THz imaging system. The pump beam and probe beam are provided from laser 61. Laser 61 is a solid-state pump laser in combination with a Ti:Sapphire oscillator which typically produces wavelengths in the range of 900 nm to 350 nm, with a pulse width of 50 fs and a repetition rate of 82 MHz. The output radiation 63 is then divided by beam splitter 65 into pump beam 31 and probe beam 33. The system should be configured such that the delay between the pump pulse and the probe pulse can be varied. In order to achieve this, the beam splitter 65 directs the probe pulse into cube mirror 67. Cube mirror 67 then reflects the pulse onto standard mirror 69. Cube mirror 67 is moveable such that the length of the optical pulse between beam splitter 65 and mirror 69 can be varied.

Typically, cube mirror 67 will be controlled by a processor which is monitoring the output signals in order to optimise the system.

The pump pulse is directed from beam splitter 65 onto sample 21 via mirror 71. The probe pulse is directed onto sample 21 via mirror 73. Sample 21 is provided on an x-y stage such that the sample can be scanned in both the x and y directions in order to image an area of the sample 21. The probe pulse 35a which is transmitted through the sample 21, is directed into detector assembly 41 via mirror 75. Detector assembly 41 has already been described in detail with reference to FIG. 3. Reflected probe pulse 35a is directed via mirror 77 into reflected probe detector which is identical to that described in detail with reference to FIG. 3.

In FIG. 4, the overlap point between the probe and pulse beams is located o the surface of the sample. However, the probe and pump beams and the sample can be configured such that the overlap point can occur anywhere within the sample.

FIG. 5 shows a further variation on the imaging system of FIG. 4. Here, a CCD camera is used to detect the image. As described with reference to FIG. 4, the pump beam and probe beam are directed onto sample 21. Prior to the probe beam impinging on sample 21, probe beam is passed through first polariser 79. For simplicity, only the transmitted probe beam 35a is shown. However, it will be appreciated that the identical arrangement could be used for the reflected probe beam 35b. Once the probe beam exits the sample, it is passed through second polariser 81. Second polariser 81 is orientated at 90° to the first polariser such that the first and second polarisers are crossed. If no THz is detected, then the probe beam will not be able to pass through the second polariser as its polarisation will be orthogonal to the transmission direction of the second polariser 81.

However, if the THz has rotated the polarisation of the probe beam, some of the probe beam 35a will be able to pass through second polariser 81. The transmitted radiation is directly related to the THz signal. Therefore, this radiation can be directly detected by a CCD camera 83 which will produce an image which is directly related to the emitted THz from the sample.

1. An apparatus for investigating a sample, the apparatus comprising:
means for irradiating the sample with a first beam of electromagnetic radiation configured to excite a second order non-linear process within the sample;
means for irradiating the sample with a second beam of electromagnetic radiation;
and a detector for detecting a change in the polarisation of the second beam after the second beam has been reflected from or transmitted through the sample.

2. An apparatus for investigating a sample, the apparatus comprising:
means for irradiating the sample with a first beam of electromagnetic radiation configured to excite an optically non-linear process within the sample such that radiation with a frequency of less than that of the first beam is generated within the sample;
means for irradiating the sample with a second beam of electromagnetic radiation;
and a detector for detecting a change in the second beam after it has been reflected from or transmitted through the sample.

3. An apparatus according to claim 2, wherein the detector is configured to detect a change in the polarisation of the second beam.

4. An apparatus according to any preceding claim, further comprises inducing means for inducing an effective second order non-linearity from a third order non-linearity.

5. An apparatus according to claim 4, wherein the inducing means comprises means to apply an electric field to the sample.

6. An apparatus according to any preceding claim, wherein the apparatus further comprises means for investigating an area of the sample and imaging means for producing an image of the said area of the sample.

7. An apparatus according to claim 6, wherein the means for imaging an area of the sample comprises means for scanning an area of the sample with both the first and second beams.

8. An apparatus according to any preceding claim, wherein the first and second beams have a frequency in the range from 100 THz to 1000 THz.

9. An apparatus according to any preceding claim, wherein the first and second beams are pulsed beams.

10. An apparatus according to claim 9, further comprising means to vary the delay between the time of arrival of the first and second beams at the sample.

11. An apparatus according to any preceding claim, wherein both the first and second beams are linearly polarised.

12. An apparatus according to any preceding claim, wherein the first beam is polarised at a different angle to that of the first beam.

13. An apparatus according to any preceding claim wherein the first and second beams overlap at a point in the sample which is to be investigated.

14. An apparatus according to claim 13, further comprising means to move the overlap point in three dimensions within the sample in order to obtain data from a selected area or volume of the sample.

15. An apparatus according to an preceding claim, wherein the apparatus further comprises means for deriving the refractive index of the sample.

17. An apparatus according to any preceding claim, wherein the detector comprises means for separating the polarisation of the second beam into orthogonal components and means for measuring the relative magnitudes of the two orthogonal components.

18. A method for investigating a sample, the method comprising the steps of:
irradiating the sample with a first beam of radiation, the first beam being configured to excite a second order optically non-linear process within the sample;
irradiating the sample with a second beam of radiation; and
detecting a change in the polarisation of the second beam which has been reflected from or transmitted through the sample.

19. A method for investigating a sample, the method comprising the steps of:
irradiating the sample with first beam of electromagnetic radiation configured to excite an optically non-linear process within the sample such that radiation with a frequency of less than that of the first beam is generated within the sample;
irradiating the sample with a second beam of electromagnetic radiation;
and detecting a change in the second beam after it has been reflected from or transmitted through the sample.

20. An apparatus as hereinbefore described with reference to any of the accompanying figures.

21. A method as hereinbefore described with reference to any of the accompanying figures.

22. An apparatus for investigating a sample, the apparatus comprising:
means for exciting a second order optically nonlinear process in a predetermined region of the sample;
means for irradiating the sample with a second beam of electromagnetic radiation, the second beam passing through or close to the predetermined region;
and a detector for detecting a change in the polarisation of the second beam after the second beam has been reflected from or transmitted through the sample.

23. Apparatus as claimed in claim 22, wherein the means for exciting the second order linear process includes means for irradiating the region with a beam of electromagnetic radiation and applying an electric field across the region.
